(19) United States
(12) Patent Application Publication
(10) Pub. No.: US 2016/0291415 A1
(43) Pub. Date: Oct. 6, 2016

(54) OPTICAL ALIGNMENT DEVICE

(71) Applicants: Boe Technology Group Co., Ltd., Beijing (CN); Beijing Boe Optoelectronics Technology Co., Ltd., Beijing (CN)

(72) Inventor: Wei Zhao, Beijing (CN)

(21) Appl. No.: 15/074,281

(22) Filed: Mar. 18, 2016

(30) Foreign Application Priority Data
Apr. 1, 2015 (CN) 201510152811.8

(51) Int. Cl. G02F 1/1337; F21V 8/00

(52) U.S. Cl. CPC G02F 1/133788; G02B 6/0056; G02B 6/0055; G02B 6/0041; G02B 6/0051; G02B 6/0053

(57) ABSTRACT

An optical alignment device, comprising: a UV light source, a light guide plate and a polarizer. The light guide plate comprises a light input surface and a light output surface. The UV light source faces the light input surface; the polarizer faces the light output surface. The optical alignment device provided by the embodiment of the present invention realizes a uniform and vertical illumination for the surface of the alignment film by means of the light guide plate. The cumulative amount of light absorbed by the entire surface of the alignment film is more uniform and the uniformity of the alignment ability for the entire surface of the alignment film is better. The brightness of the dark state during display can be further reduced, thereby realizing a higher contrast and improving the display effect.

### RELATED APPLICATIONS

The present application claims the benefit of Chinese Patent Application No. 201510152811.8, filed Apr. 1, 2015, the entire disclosure of which is incorporated herein by reference.

### FIELD OF THE INVENTION

The present invention relates to the field of display technology, in particular to an optical alignment device.

### BACKGROUND OF THE INVENTION

A liquid crystal display (LCD) panel typically comprises two substrates (i.e., an array substrate and a color film substrate), a liquid crystal layer inserted between them and polarizers on the outsides of the substrates. These two substrates respectively comprise a pixel electrode and a common electrode for forming an electric field. In the LCD, by applying a voltage to the electrodes, an electric field can be generated in the liquid crystal layer, determining the alignment of the liquid crystal molecules in the liquid crystal layer, and controlling the polarization of the incident light, thereby performing image display. Before applying the voltage, the liquid crystal molecules should have an initial alignment orientation, therefore an alignment film is arranged in the display panel. FIG. 1 is a structural schematic diagram of an optical alignment device in the prior art, which comprises a UV light source 110 and a polarizer 120. A schematic diagram of the alignment process for an alignment film using an existing optical alignment device is shown in FIG. 2: a UV light source 110 emits light, which is converted to polarized light after passing through a polarizer 120 and then directed to an alignment film 130 located on a surface of a substrate 140. By replacing the existing alignment approach of rubbing cloth with the optical alignment technology using an optical alignment device, many defects caused by the alignment of rubbing cloth can be effectively improved; at the same time, the pretilt angle of liquid crystal molecules can be accurately determined, realizing a better display effect. However, the polarized light is not uniformly distributed in the vertical direction, and should be adjusted with a process, such as an adjustment by moving the bearing platform back and forth several times to realize an adequate illumination and uniform illumination energy. This method can to some extent improve the illumination uniformity. However, in an optical alignment process, the uniformity of the light should be maintained during illuminating the alignment film, so as to ensure the uniformity of the energy absorbed by the surface of the alignment film on the entire substrate; if the uniformity can not be maintained, there is excessive exposure for some areas and insufficient exposure for other areas, affecting the uniformity of the alignment film, and ultimately affecting the display quality.

### SUMMARY OF THE INVENTION

It is thus desired to realize a uniform illumination for the surface of the alignment film.

To this end, an embodiment of the present invention provides an optical alignment device comprising: a UV light source, a light guide plate and a polarizer; the light guide plate comprises a light input surface and a light output surface; the UV light source faces the light input surface; the polarizer faces the light output surface.

Optionally, the light input surface is located on a lateral edge of the light guide plate; a reflective plate is arranged on a side of the light guide plate departing from the light output surface.

Optionally, the UV light source is provided with a lamp shade for reflecting light.

Optionally, the light input surface is located on a side of the light guide plate departing from the light output surface.

Optionally, the optical alignment device further comprises a reflective plate located on a side of the light guide plate departing from the light output surface; the UV light source is located between the reflective plate and the light guide plate.

Optionally, microstructures for diffusing light are provided within the light guide plate.

Optionally, the microstructures are lattice points.

Optionally, the optical alignment device further comprises at least one of a diffusion sheet and a prism sheet located on a side of the light output surface of the light guide plate.

Optionally, the diffusion sheet is located between the light guide plate and the polarizer.

Optionally, the prism sheet is located between the light guide plate and the polarizer.

Optionally, the diffusion sheet and the prism sheet are both located between the light guide plate and the polarizer.

Optionally, the prism sheet is located between the diffusion sheet and the polarizer.

The optical alignment device provided by the embodiment of the present invention realizes a uniform and vertical illumination for the surface of the alignment film by means of the light guide plate; the cumulative amount of light absorbed by the entire surface of the alignment film is more uniform, the uniformity of the alignment ability for the entire surface of the alignment film is better; the brightness of the dark state during display can be further reduced, thereby realizing a higher contrast and improving the display effect.

### BRIEF DESCRIPTION OF THE DRAWINGS

FIG. 1 is a structural schematic diagram of an optical alignment device in the prior art;

FIG. 2 is a schematic diagram of an alignment process using the optical alignment device in FIG. 1;

FIG. 3 is a structural schematic diagram of an optical alignment device according to an embodiment of the present invention;

FIG. 4 is a schematic diagram of an alignment process using the optical alignment device in FIG. 3; and

FIG. 5 is a structural schematic diagram of another optical alignment device according to an embodiment of the present invention.

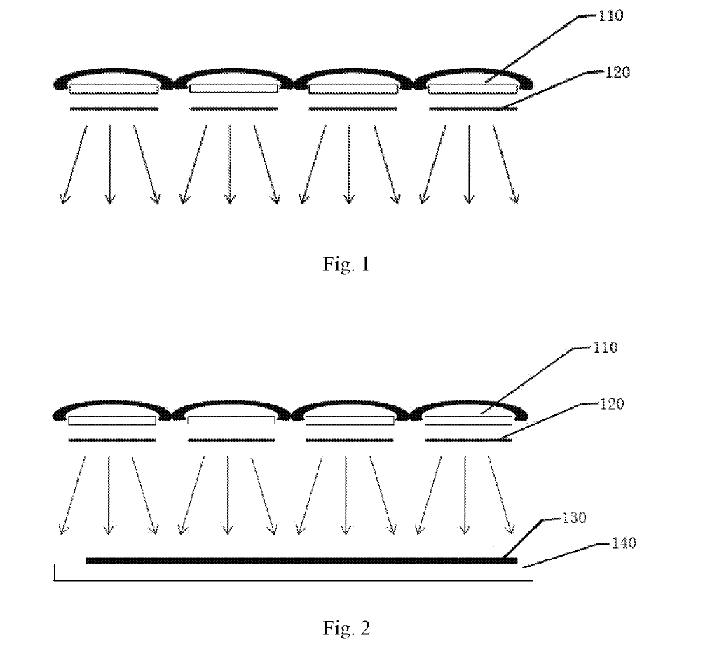

### DETAILED DESCRIPTION OF THE INVENTION

The implementation of the present invention will be described below in more detail in combination with the drawings and the embodiments. The following embodiments are used for explanation of the present invention, not for limitation of the scope of the present invention.

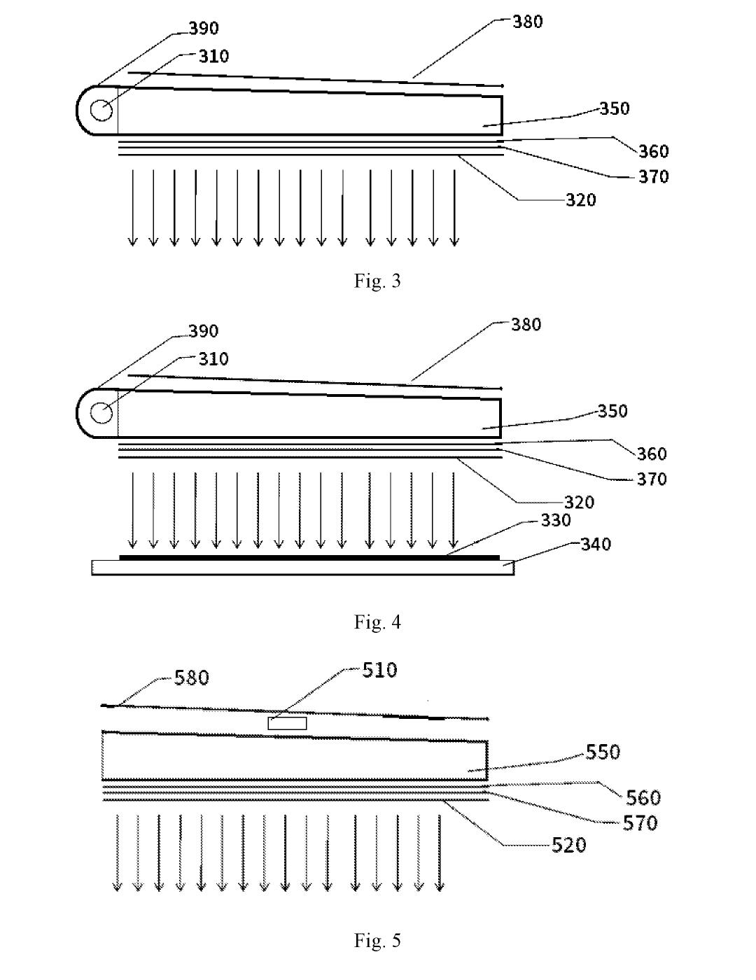

An optical alignment device provided by an embodiment of the present invention is shown in FIG. 3. The optical alignment device comprises: a UV light source 310, a light guide plate 350 and a polarizer 320; the light guide plate 350 comprises a light input surface and a light output surface; the UV light source 310 faces the light input surface; the polarizer 320 faces the light output surface. In such a manner, the light guide plate realizes a uniform and vertical illumination for the surface of the alignment film; the cumulative amount of light absorbed by the entire surface of the alignment film is more uniform, the uniformity of the alignment ability for the entire surface of the alignment film is better; the brightness of the dark state during display can be further reduced, thereby realizing a higher contrast and improving the display effect.

Optionally, the light input surface is located on a lateral edge of the light guide plate 350; a reflective plate 380 is arranged on a side of the light guide plate 350 departing from the light output surface. The light guide plate 350 is made of a transparent material, there may be a loss of light and a low utilization ratio of light if there is no reflective plate 380 arranged on a side of the light guide plate 350 departing from the light output surface. The reflective plate 380 can reflect light emitted from the side departing from the light output surface back to the light guide plate 350, thereby improving the utilization ratio of light.

Optionally, the UV light source 310 is provided with a lamp shade 390 for reflecting light, such that all of the UV light can enter the light guide plate 350.

Optionally, microstructures for diffusing light are provided within the light guide plate 350; the microstructures can be lattice points.

By providing, for example, lattice points within the light guide plate, when the lattice points are illuminated by the light, the reflected light can be diffused in all directions and eventually emitted from the light output surface of the light guide plate; by providing lattice points with different distribution densities and sizes, the light passing through the light guide plate can be emitted uniformly.

Optionally, to make the emitted light more uniform, the optical alignment device further comprises a diffusion sheet 360 located on a side of the light output surface of the light guide plate 350. Wherein the operating principle of the diffusion sheet 360 is fogging the light source with refraction and reflection of the diffusion material, concentrating the light emitted in a small angle to the front, so as to improving the brightness of the front, projecting the concentrated light uniformly.

Optionally, to direct the light to the surface of the alignment film more vertically, the optical alignment device further comprises a prism sheet 370 located on a side of the light output surface of the light guide plate 350. The function of the prism sheet 370 is to improve the angle distribution of light; the prism sheet 370 can concentrate the light emitted uniformly in all directions into an axis direction (i.e., a direction of elevation view), improving the axial brightness without increasing the total luminous flux of the emitted light; that is, the light can be directed to the surface vertically.

The arrangement sequence of the diffusion sheet 360, prism sheet 370, and polarizer 320 on the side of the light output surface of the light guide plate 350 can be adjusted at will. Optionally, the diffusion sheet 360 is located between the light guide plate 350 and the polarizer 320; or, the prism sheet 370 is located between the light guide plate 350 and the polarizer 320; or, the diffusion sheet 360 and the prism sheet 370 are both located between the light guide plate 350 and the polarizer 320; the prism sheet 370 is located between the diffusion sheet 360 and the polarizer 320. In such a manner, the polarized light can then be eventually emitted uniformly and vertically.

As shown in FIG. 4, the polarized light emitted by the optical alignment device according to the embodiment of the present invention illuminates the surface of the alignment film 330 on the substrate 340.

In the above mentioned embodiment, the UV light source 310 is located on a side of a lateral edge of the light guide plate 350, forming a side type light guide structure; the light guide structure can also be a direct type light guide structure.

An optical alignment device according to another embodiment of the present invention is shown in FIG. 5. The light input surface of the light guide plate 510 is located on a side of the light guide plate 510 departing from the light output surface; the UV light source 510 faces the light input surface. The optical alignment device can further comprise a reflective plate 580 located on a side of the light guide plate 510 departing from the light output surface; the UV light source 510 can be located between the reflective plate 580 and the light guide plate 510. An polarizer 520 is located on the side of the light output surface of the light guide plate 550.

Optionally, to make the emitted light more uniform, the optical alignment device further comprises a diffusion sheet 560 located on a side of the light output surface of the light guide plate 550. Wherein the operating principle of the diffusion sheet 560 is fogging the light source with refraction and reflection of the diffusion material, concentrating the light emitted in a small angle to the front, so as to improving the brightness of the front, projecting the concentrated light uniformly.

Optionally, to direct the light to the surface of the alignment film more vertically, the optical alignment device further comprises a prism sheet 570 located on a side of the light output surface of the light guide plate 550. The function of the prism sheet 570 is to improve the angle distribution of light; the prism sheet 370 can concentrate the light emitted uniformly in all directions into an axis direction (i.e., a direction of elevation view), improving the axial brightness without increasing the total luminous flux of the emitted light; that is, the light can be directed to the surface vertically.

The arrangement sequence of the diffusion sheet 560, prism sheet 570 and polarizer 520 on the side of the light output surface of the light guide plate 550 can be adjusted at will. Optionally, the diffusion sheet 560 is located between the light guide plate 550 and the polarizer 520; or, the prism sheet 570 is located between the light guide plate 550 and the polarizer 520; or, the diffusion sheet 560 and the prism sheet 570 are both located between the light guide plate 550 and the polarizer 520; the prism sheet 570 is located between the diffusion sheet 560 and the polarizer 520. In such a manner, the polarized light can then be eventually emitted uniformly and vertically.

The structure and principle of the light guide plate in the optical alignment device of the above mentioned embodiment are same with those of a light guide plate in a backlight of a display device, which are not repeated herein.

The size of the optical alignment device can be arranged according to the lateral length of the substrate; the alignment process can be performed with only one UV light source. A uniform illumination for the substrate in the lateral direction can be realized; the exposure of the alignment film can be accomplished by moving the substrate in the longitudinal direction only once. Therefore, compared to the traditional device, the optical alignment device can not only ensure a uniform polarized light illumination on the surface of the alignment, but also reduce the number of the light source, thereby decreasing the cost. Meanwhile, the exposure can be accomplished by moving the optical alignment device only once, reducing the illumination time, improving the process efficiency, and enhancing the productivity.

The above embodiments are only used for explanations rather than limitations to the present invention, the ordinary skilled person in the related technical field, in the case of not departing from the spirit and scope of the present invention, may also make various modifications and variations, therefore, all the equivalent solutions also belong to the scope of the present invention, the patent protection scope of the present invention should be defined by the claims.

1. An optical alignment device comprising:
a UV light source;
a light guide plate and
a polarizer;
wherein the light guide plate comprises:
a light input surface and a light output surface;
wherein the UV light source faces the light input surface; and
wherein the polarizer faces the light output surface.

2. The optical alignment device according to claim 1, wherein
the light input surface is located on a lateral edge of the light guide plate; and wherein
a reflective plate is arranged on a side of the light guide plate departing from the light output surface.

3. The optical alignment device according to claim 2, wherein the UV light source is provided with a lamp shade for reflecting light.

4. The optical alignment device according to claim 1, wherein the light input surface is located on a side of the light guide plate departing from the light output surface.

5. The optical alignment device according to claim 4, further comprising:
a reflective plate located on a side of the light guide plate departing from the light output surface, wherein the UV light source is located between the reflective plate and the light guide plate.

6. The optical alignment device according to claim 1, wherein microstructures for diffusing light are provided within the light guide plate.

7. The optical alignment device according to claim 6, wherein the microstructures are lattice points.

8. The optical alignment device according to claim 1, further comprising at least one of a diffusion sheet and a prism sheet located on a side of the light output surface of the light guide plate.

9. The optical alignment device according to claim 8, wherein at least one of the diffusion sheet and prism sheet are located between the light guide plate and the polarizer.

10. The optical alignment device according to claim 8, wherein the diffusion sheet and the prism sheet are both located between the light guide plate and the polarizer.

11. The optical alignment device according to claim 10, wherein the prism sheet is located between the diffusion sheet and the polarizer.

12. The optical alignment device according to claim 2, further comprising at least one of a diffusion sheet and a prism sheet located on a side of the light output surface of the light guide plate.

13. The optical alignment device according to claim 12, wherein at least one of the diffusion sheet and the prism sheet are located between the light guide plate and the polarizer.

14. The optical alignment device according to claim 12, wherein the diffusion sheet and the prism sheet are both located between the light guide plate and the polarizer.

15. The optical alignment device according to claim 14, wherein the prism sheet is located between the diffusion sheet and the polarizer.

16. The optical alignment device according to claim 4, further comprising at least one of a diffusion sheet and a prism sheet located on a side of the light output surface of the light guide plate.

17. The optical alignment device according to claim 16, wherein at least one of the diffusion sheet and the prism sheet are located between the light guide plate and the polarizer.

18. The optical alignment device according to claim 16, wherein the diffusion sheet and the prism sheet are both located between the light guide plate and the polarizer.

19. The optical alignment device according to claim 18, wherein the prism sheet is located between the diffusion sheet and the polarizer.
